(19) United States
(12) Patent Application Publication
(10) Pub. No.: US 2018/0358913 A1
(43) Pub. Date: Dec. 13, 2018

(54) MOTOR CONTROL APPARATUS, SHEET CONVEYANCE APPARATUS, DOCUMENT FEEDING APPARATUS, DOCUMENT READING APPARATUS, AND IMAGE FORMING APPARATUS

(71) Applicant: CANON KABUSHIKI KAISHA, Tokyo (JP)

(72) Inventor: Ken Ogihara, Toride-shi (JP)

(21) Appl. No.: 15/988,450

(22) Filed: May 24, 2018

(30) Foreign Application Priority Data
Jun. 8, 2017 (JP) 2017-113619

(51) Int. Cl. H02P 21/22; H02P 8/12; H02P 21/34; H02P 21/04; G03G 15/00

(52) U.S. Cl. CPC H02P 21/22; H02P 8/12; G03G 15/6508; H02P 21/04; G03G 15/6529; H02P 21/34

(57) ABSTRACT

A motor control apparatus, to control a motor based on an instruction phase representing a target phase of a rotor of the motor, includes a phase determiner, to determine a rotation phase of the motor rotor, and a controller having a first control mode to control a drive current flowing through a winding of the motor and a second control mode to supply a current to the winding corresponding to an instruction phase. To reduce a deviation between the instruction and rotation phases, the first control mode results in flowing drive current control based on a rotating coordinate system represented torque current component generating a torque in the rotor. The second control mode results in phase different drive current control first instruction phase. The controller starts the first control mode based on the rotation phase of the rotor determined based on the second instruction phase in the second control mode.

### BACKGROUND OF THE INVENTION

### Field of the Invention

The present disclosure relates to motor control in a motor control apparatus, a sheet conveyance apparatus, a document feeding apparatus, a document reading apparatus, and an image forming apparatus.

### Description of the Related Art

As a motor control method, a method of controlling a motor by controlling a current value in a rotating coordinate system based on the rotation phase of the rotor of the motor has heretofore been known. This control method is referred to as vector control (US 2003/0178965).

In vector control, a drive current flowing through each of windings of a motor is represented by a q-axis component (torque current component) for generating a torque for rotating the rotor and a d-axis component (exciting current component) that is a current component affecting the intensities of magnetic fluxes penetrating the windings of the motor. A torque required for rotating the rotor is efficiently generated by controlling the value of the torque current component in response to a variation of a load torque applied to the rotor. As a result, an increase in motor sound and an increase in power consumption due to excessive torque can be prevented. If the load torque applied to the rotor exceeds the output torque corresponding to the drive currents supplied to the windings of the motor, the rotor does not synchronize with an input signal, resulting in an uncontrollable state (step-out state) of the motor. The above-described vector control prevents the motor from entering the uncontrollable state.

In vector control, the motor is controlled based on the rotation phase of the rotor. Specifically, when driving of the motor is started by vector control, vector control is performed based on the rotation phase (initial phase) of the rotor at the time when driving of the motor is started. Accordingly, when driving of the motor is started by vector control, it is necessary to determine the initial phase of the rotor before driving of the motor is started.

As a method for determining the initial phase of the rotor, a method in which a predetermined current is supplied to each winding of a motor and the rotation phase of a rotor attracted to a magnetic field generated due to the supplied current is determined as the initial phase is known. Specifically, for example, as illustrated in FIG. 8A, a predetermined current is supplied to the phase A winding of the motor, and the rotor is rotated by the magnetic field generated due to the current. A method in which the rotation phase of the rotor attracted to the magnetic field as described above is determined as the initial phase is known.

In the method described above, for example, an issue as illustrated in FIG. 8B may be caused. Specifically, when the orientation of the magnetic field generated by the rotor is different by 180 degrees from the orientation of the magnetic field generated due to the current flowing through the winding, a torque is not generated in the rotor even when a current is supplied to the winding. In this case, when the initial phase is determined as described above, the phase difference between the initial phase and the actual rotation phase of the rotor is 180°. Thus, if the motor control is started based on the initial phase in a state where the determined initial phase is different from the actual rotation phase of the rotor, the motor control may become unstable.

### SUMMARY OF THE INVENTION

In view of the above-described issues, the present disclosure is directed to preventing motor control from being unstable.

According to an aspect of the present invention, a motor control apparatus to control a motor based on an instruction phase representing a target phase of a rotor of the motor, includes a phase determiner configured to determine a rotation phase of the rotor of the motor, and a controller having a first control mode for controlling a drive current flowing through a winding of the motor, based on a torque current component generating a torque in the rotor, so as to reduce a deviation between the instruction phase and the rotation phase determined by the phase determiner, and a second control mode for controlling a current corresponding to the instruction phase to the winding, wherein the torque current component is represented in a rotating coordinate system based on the rotation phase determined by the phase determiner, wherein, in the second control mode, the controller controls the drive current in such a manner that a current corresponding to a first instruction phase as the instruction phase flows through the winding and then controls the drive current in such a manner that a current corresponding to a second instruction phase flows through the winding, wherein the second instruction phase has a phase difference other than 0° and 180° between the first instruction phase and the second instruction phase, wherein the phase determiner determines the rotation phase of the rotor based on the second instruction phase, and wherein the controller starts the first control mode based on the rotation phase of the rotor determined by the phase determiner based on the second instruction phase in the second control mode.

Further features of the present disclosure will become apparent from the following description of embodiments (with reference to the attached drawings).

### BRIEF DESCRIPTION OF THE DRAWINGS

FIG. 1 is a sectional view illustrating an image forming apparatus according to a first embodiment.

FIG. 2 is a block diagram illustrating a control configuration of the image forming apparatus.

FIG. 3 is a diagram illustrating a relationship between a two-phase motor including a phase A and a phase B and a rotating coordinate system represented by a d-axis and a q-axis.

FIG. 4 is a block diagram illustrating a configuration of a motor control apparatus according to the first embodiment.

FIG. 5 is a graph illustrating an example of a pulse output from an encoder.

FIGS. 6A to 6D are diagrams, each illustrating a method for determining an initial phase.

FIG. 7 is a flowchart illustrating a motor control method according to the first embodiment.

FIGS. 8A and 8B are diagrams each illustrating an initial phase determination method of related art.

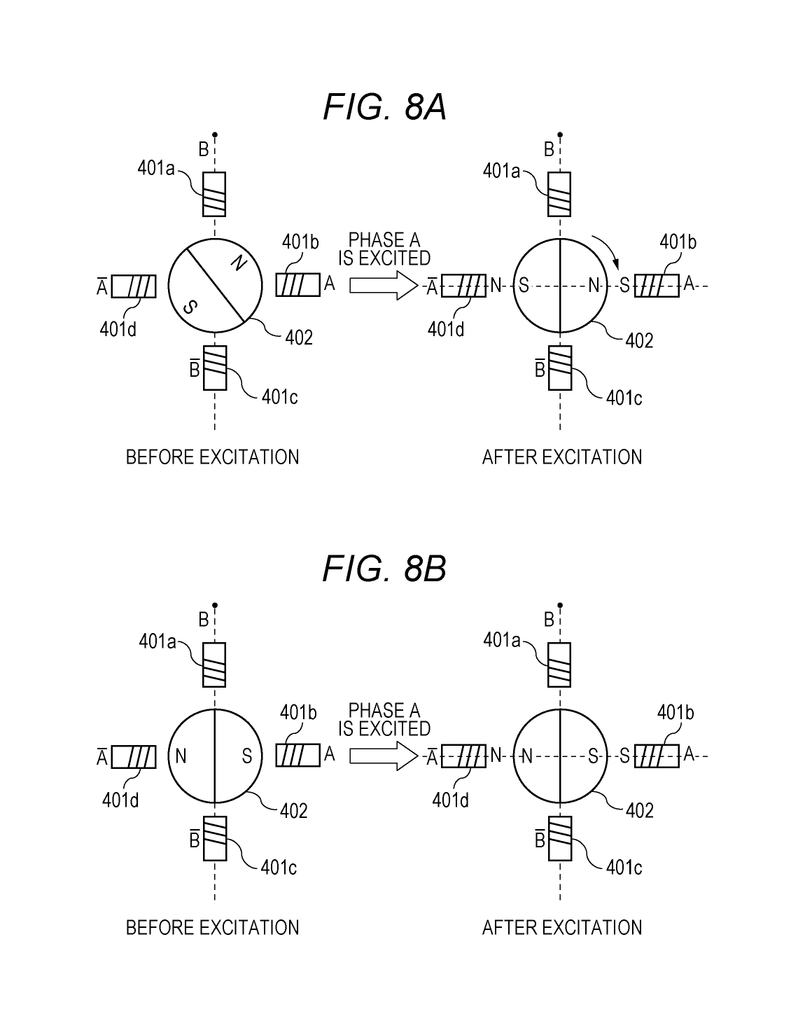

FIG. 9 is a block diagram illustrating a configuration of a motor control apparatus that performs speed feedback control.

### DESCRIPTION OF THE EMBODIMENTS

Embodiments of the present disclosure will be described below with reference to the drawings. However, shapes and relative arrangements of components described in the embodiments should be modified as needed depending on the configuration of an apparatus according to the present disclosure and other various conditions. The scope of the present disclosure is not limited to the embodiments described below. Although, in the following descriptions, a motor control apparatus is included in an image forming apparatus, the location of a motor control apparatus is not limited thereto. For example, a motor control apparatus is also used for a sheet conveyance apparatus for conveying sheets such as recording media and documents.

### First Embodiment

[Image Forming Apparatus]

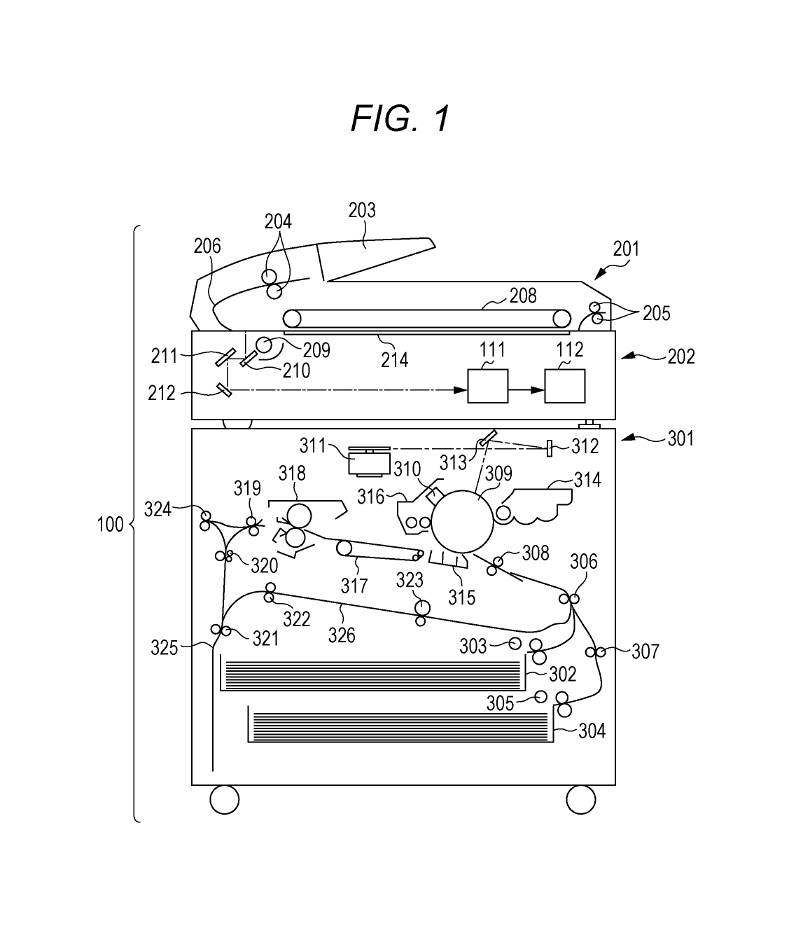

FIG. 1 is a sectional view illustrating a configuration of a monochromatic electrophotographic copier (hereinafter referred to as an image forming apparatus) 100 including a sheet conveyance apparatus used in an embodiment of the present disclosure. The image forming apparatus is not limited to a copier and may be, for example, a facsimile, a printing machine, or a printer. The recording process is not limited to the electrophotographic process and instead may be, for example, an inkjet method. Further, the type of the image forming apparatus 100 may be either a monochrome type or a color type.

The configuration and functions of the image forming apparatus 100 will be described below with reference to FIG. 1. As illustrated in FIG. 1, the image forming apparatus 100 includes a document feeding apparatus 201, a reading apparatus 202, and an image printing apparatus 301.

Documents stacked on a document stacking portion 203 of the document feeding apparatus 201 are fed one by one by sheet feed rollers 204 and conveyed onto a document positioning glass plate 214 of the reading apparatus 202 along a conveyance guide 206. Further, the documents are conveyed at a constant speed by a conveyance belt 208 and discharged onto a discharge tray, which is not illustrated, by discharge rollers 205. Light reflected from a document image illuminated by an illumination system 209 at a reading position of the reading apparatus 202 is guided to an image reading unit 111 by an optical system including reflection mirrors 210, 211, and 212 and is converted into an image signal by the image reading unit 111. The image reading unit 111 includes lenses, a charge coupled device (CCD) that is a photoelectric conversion element, and a driving circuit for driving the CCD. The image signal output from the image reading unit 111 undergoes various kinds of correction processing by an image processing unit 112 including hardware devices such as an application specific integrated circuit (ASIC). Then, the image signal is output to the image printing apparatus 301. A document reading process is thus performed. In other words, the document feeding apparatus 201 and the reading apparatus 202 function as a document reading apparatus.

There are two different document reading modes: a first reading mode and a second reading mode. The first reading mode is a mode in which the illumination system 209 and the optical system fixed to a predetermined position read an image of a document being conveyed at a constant speed. The second reading mode is a mode in which the illumination system 209 and the optical system moving at a constant speed read an image of a document placed on the document positioning glass plate 214 of the reading apparatus 202. Typically, an image of a document sheet is read in the first reading mode, and an image of a bound document, such as a book or booklet is read in the second reading mode.

The image printing apparatus 301 includes sheet storage trays 302 and 304. The sheet storage trays 302 and 304 can store different types of recording media. For example, A4-size plain paper is stored in the sheet storage tray 302, and A4-size thick paper is stored in the sheet storage tray 304. A recording medium refers to a medium on which an image is formed by the image forming apparatus 100. Examples of the recording medium include paper, resin sheets, cloths, overhead projector (OHP) sheets, and labels.

A recording medium stored in the sheet storage tray 302 is fed by a sheet feed roller 303 and then is sent to registration rollers 308 by conveyance rollers 306 and 307. A recording medium stored in the sheet storage tray 304 is fed by a sheet feed roller 305 and then is sent to the registration rollers 308 by conveyance rollers 306 and 307.

The image signal output from the reading apparatus 202 is input to a light scanning apparatus 311 including a semiconductor laser device and a polygon mirror. The outer circumferential surface of a photosensitive drum 309 is charged by a charging unit 310. After the outer circumferential surface of the photosensitive drum 309 is charged, the outer circumferential surface of the photosensitive drum 309 is irradiated with laser light, which is input from the reading apparatus 202 to the light scanning apparatus 311, from the light scanning apparatus 311 via the polygon mirror and the mirrors 312 and 313. As a result, an electrostatic latent image is formed on the outer circumferential surface of the photosensitive drum 309. To charge the photosensitive drum, for example, a charging method using a corona charging unit or a charging roller is employed.

Then, the electrostatic latent image is developed using toner in a developing unit 314 to form a toner image on the outer circumferential surface of the photosensitive drum 309. The toner image formed on the photosensitive drum 309 is transferred onto the recording medium by a transfer charging unit 315 disposed at a position (transfer position) facing the photosensitive drum 309. In synchronization with the transfer timing, the registration rollers 308 send the recording medium to the transfer position.

As described above, the recording medium with the toner image transferred thereon is sent to a fixing unit 318 by a conveyance belt 317, and heated and pressurized by the fixing unit 318. Then, the toner image is fixed onto the recording medium. In this manner, an image is formed on the recording medium by the image forming apparatus 100.

When an image formation process is performed in a one-side printing mode, the recording medium that has passed through the fixing unit 318 is discharged onto a discharge tray, which is not illustrated, by discharge rollers 319 and 324. When an image formation process is performed in a both-sided printing mode, a first surface of the recording medium undergoes fixing processing by the fixing unit 318, and then the recording medium is conveyed to an inversion path 325 by the discharge rollers 319, conveyance rollers 320, and inversion rollers 321. After that, the recording medium is conveyed again to the registration rollers 308 by conveyance rollers 322 and 323, and an image is formed on a second surface of the recording medium by the above-described method. Then, the recording medium is discharged onto the discharge tray, which is not illustrated, by the discharge rollers 319 and 324.

In a case where the recording medium with an image formed on the first surface is discharged to the outside of the image forming apparatus 100 in a face-down state, the recording medium that has passed through the fixing unit 318 passes through the discharge rollers 319, and is conveyed in a direction toward the conveyance roller 320. Then, immediately before the trailing edge of the recording medium passes through a nip portion of the conveyance rollers 320, the rotation of the conveyance rollers 320 is reversed. Thus, the recording medium passes through the discharge rollers 324 and is discharged to the outside of the image forming apparatus 100 in a state where the first surface of the recording medium faces down.

The configuration and functions of the image forming apparatus 100 have been described above. In the present embodiment, loads refer to targets to be driven by a motor. For example, various rollers (conveyance rollers) including the feed rollers 204, 303, and 305, the registration rollers 308, and the discharge rollers 319, the photosensitive drum 309, the conveyance belts 208 and 317, the illumination system 209, and the optical system correspond to the loads according to the present embodiment. A motor control apparatus according to the present embodiment is applicable to the motor for driving these loads.

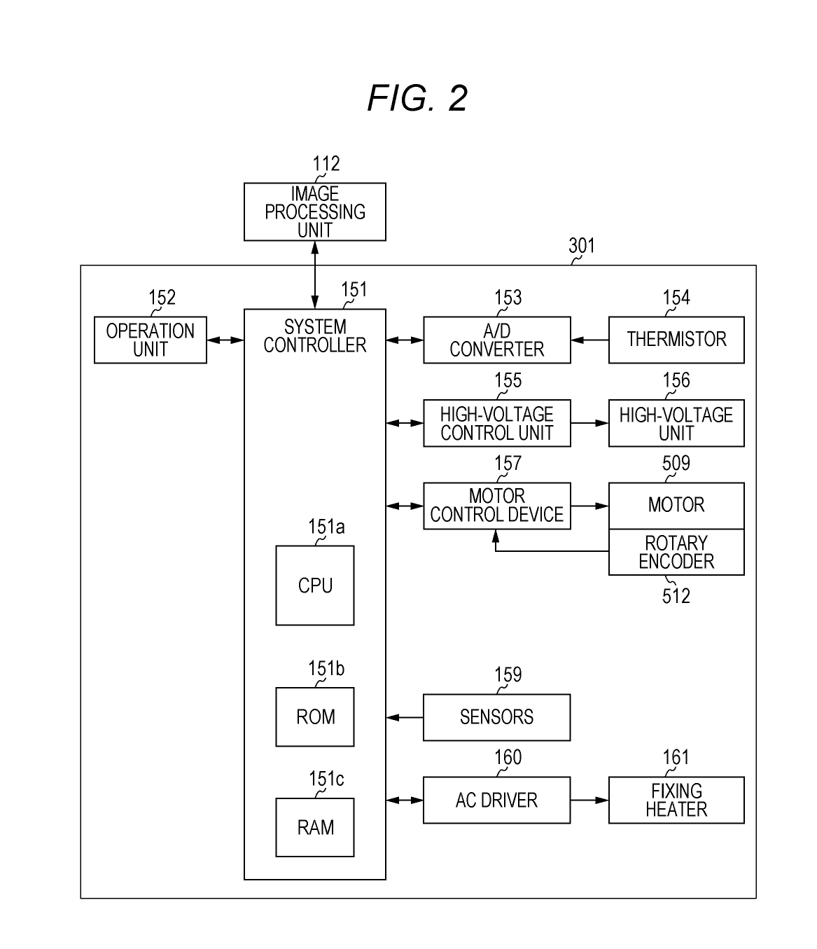

FIG. 2 is a block diagram illustrating an example of a control configuration of the image forming apparatus 100. As illustrated in FIG. 2, a system controller 151 includes a central processing unit (CPU) 151a, a read only memory (ROM) 151b, and a random access memory (RAM) 151c. The system controller 151 is connected to the image processing unit 112, an operation unit 152, an analog-to-digital (A/D) converter 153, a high-voltage control unit 155, a motor control apparatus 157, sensors 159, and an alternating current (AC) driver 160. The system controller 151 can transmit and receive data and commands to and from the connected units.

The CPU 151a reads various programs stored in the ROM 151b and then executes various sequences related to a predetermined image forming sequence.

The RAM 151c is a storage device. The RAM 151c stores various kinds of data including setting values for the high-voltage control unit 155, instruction values for the motor control apparatus 157, and information received from the operation unit 152.

The system controller 151 transmits, to the image processing unit 112, various setting value data of the apparatuses included in the image forming apparatus 100. The setting value data is required for image processing by the image processing unit 112. Further, the system controller 151 receives signals from the sensors 159, and sets the setting values of the high-voltage control unit 155 based on the received signals.

The high-voltage control unit 155 supplies voltages required for high-voltage units 156 (the charging unit 310, the developing unit 314, the transfer charging unit 315, etc.) according to the setting values set by the system controller 151. The sensors 159 include sensors for detecting a recording medium conveyed by the conveyance rollers.

The motor control apparatus 157 controls a motor 509 for driving loads in response to an instruction output from the CPU 151a. Although, in FIG. 2, only the motor 509 is illustrated as a motor for the image forming apparatus 100, it is assumed, in practice, that a plurality of motors is included in the image forming apparatus 100. One motor control apparatus 157 may be configured to control a plurality of motors. Although, in FIG. 2, only one motor control apparatus 157 is included in the image forming apparatus 100, assume that a plurality of motor control apparatuses is actually included in the image forming apparatus 100.

The A/D converter 153 receives a detection signal detected by a thermistor 154 for detecting the temperature of a fixing heater 161, converts the detection signal from an analog signal into a digital signal, and transmits the digital signal to the system controller 151. The system controller 151 controls the AC driver 160 based on the digital signal received from the A/D converter 153. The AC driver 160 controls the temperature of the fixing heater 161 to attain the temperature required to perform fixing processing. The fixing heater 161 is used for fixing processing and is included in the fixing unit 318.

The system controller 151 controls the operation unit 152 to display, on a display unit of the operation unit 152, operation screens for allowing a user to set, for example, the type of the recording medium to be used (hereinafter referred to as a paper type). The system controller 151 receives information set by the user from the operation unit 152 and controls operation sequences of the image forming apparatus 100 based on information set by the user. The system controller 151 transmits information indicating the state of the image forming apparatus 100 to the operation unit 152. The information indicating the state of the image forming apparatus 100 refers to information about, for example, the number of sheets for image formation, the progress of the image forming operation, and sheet jam and double feed in the document feeding apparatus 201 and the image printing apparatus 301. The operation unit 152 displays information received from the system controller 151 on the display unit.

As described above, the system controller 151 controls operation sequences of the image forming apparatus 100.

[Motor Control Apparatus]

Next, the motor control apparatus 157 according to the present embodiment will be described below. The motor control apparatus 157 according to the present embodiment controls a motor using vector control. In the following description, the following control processing is performed based on electrical angles such as a rotation phase 19, an instruction phase θ_ref, a current phase, and the like. However, the following control processing may be performed based on, for example, a mechanical angle.

<Vector Control>

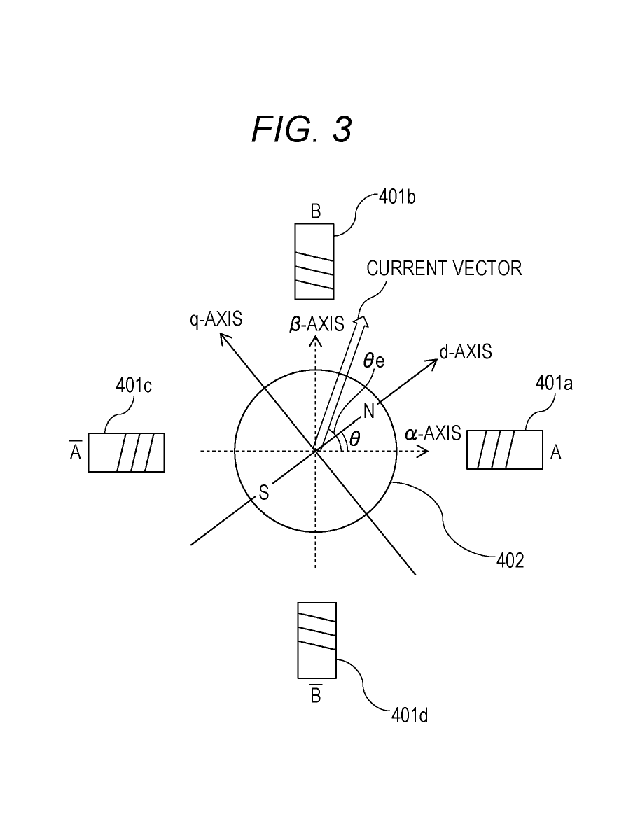

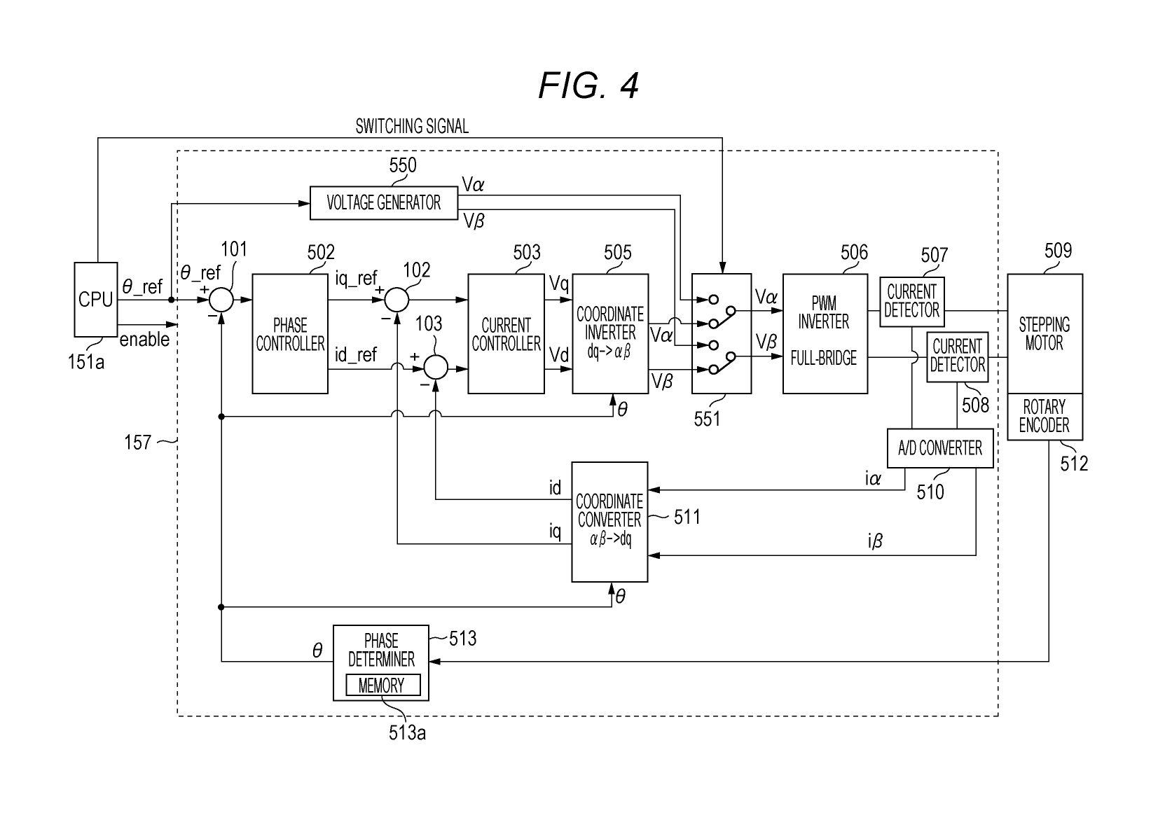

First, a method in which the motor control apparatus 157 performs vector control as the first control mode according to this embodiment will be described with reference to FIGS. 3 and 4.

FIG. 3 is a diagram illustrating a relationship between a stepping motor (hereinafter referred to as a motor) 509 including two phases, i.e., a phase A (first phase) and a phase B (second phase) and a rotating coordinate system represented by a d-axis and a q-axis. Referring to FIG. 3, in a stationary coordinate system, an α-axis which is an axis corresponding to a phase A winding and a β-axis which is an axis corresponding to a phase B winding are defined. Referring to FIG. 3, a d-axis is defined in a direction of a magnetic flux generated by a magnetic pole of a permanent magnet used as the rotor 402, and a q-axis is defined in a direction (direction perpendicular to the d-axis) that leads the d-axis by 90 degrees in a counterclockwise direction. The angle formed between the α-axis and the d-axis is defined as θ and the rotation phase of the rotor 402 is represented by the angle θ. In the vector control, the rotating coordinate system based on the rotation phase θ of the rotor 402 is used. Specifically, in the vector control, the q-axis component (torque current component) generating a torque in the rotor 402 and the d-axis component (exciting current component) affecting the intensities of the magnetic fluxes penetrating the windings are used. These components are current components of the current vector corresponding to the drive currents flowing through the windings in the rotating coordinate system.

Vector control refers to a control method for controlling a motor by performing phase feedback control in which the value of the torque current component and the value of the exciting current component are controlled so as to reduce a deviation between an instruction phase representing a target phase of the rotor and an actual rotation phase of the rotor. There is another method for controlling a motor by performing speed feedback control in which the value of the torque current component and the value of the exciting current component are controlled so as to reduce a deviation between an instruction speed representing a target speed of the rotor and an actual rotation speed of the rotor.

FIG. 4 is a block diagram illustrating an example of the configuration of the motor control apparatus 157 that controls the motor 509. The motor control apparatus 157 includes at least one ASIC and executes functions described below.

As illustrated in FIG. 4, the motor control apparatus 157 includes, as circuits for performing vector control, a phase controller 502, a current controller 503, a coordinate inverter 505, a coordinate converter 511, and a pulse width modulation (PWM) inverter 506 that supplies the drive currents to the windings of the motor. The coordinate converter 511 converts current vectors respectively corresponding to the drive currents flowing through the phase A winding and the phase B winding of the motor 509, from a stationary coordinate system represented by the α-axis and the β-axis to a rotating coordinate system represented by the q-axis and the d-axis. As a result, the drive currents flowing through the windings are represented by the current value of a q-axis component, which is a current value in the rotating coordinate system, and the current value (d-axis current) of a d-axis component. The q-axis current corresponds to the torque current for generating a torque in the rotor 402 of the motor 509. The d-axis current corresponds to the exciting current affecting the intensities of the magnetic fluxes penetrating the windings of the motor 509. The motor control apparatus 157 can independently control each of the q-axis current and the d-axis current. As a result, the motor control apparatus 157 can efficiently generate a torque required for the rotation of the rotor 402 by controlling the q-axis current according to a load torque applied to the rotor 402. In other words, in the vector control, the magnitude of the current vector illustrated in FIG. 3 varies depending on the load torque applied to the rotor 402.

The motor control apparatus 157 determines the rotation phase θ of the rotor 402 of the motor 509 and performs vector control based on the determination result. The CPU 151a generates the instruction phase θ_ref representing the target phase of the rotor 402 of the motor 509 and outputs the generated instruction phase θ_ref to the motor control apparatus 157. In practice, the CPU 151a outputs a pulse signal to the motor control apparatus 157, and the number of pulses corresponds to the instruction phase and the pulse frequency corresponds to the target speed. The instruction phase θ_ref is generated based on, for example, the target speed of the motor 509.

A subtracter 101 calculates a deviation between the rotation phase θ and the instruction phase θ_ref of the rotor 402 of the motor 509, and outputs the calculated deviation.

The phase controller 502 acquires a deviation Δθ for a period T (e.g., 200 μs). The phase controller 502 generates and outputs a q-axis current instruction value (target value) iq_ref and a d-axis current instruction value (target value) id_ref based on proportional control (P), integral control (I), and differential control (D) so as to reduce the deviation output from the subtracter 101. Specifically, the phase controller 502 generates and outputs the q-axis current instruction value iq_ref and the d-axis current instruction value id_ref based on P control, I control, and D control so that the deviation output from the subtracter 101 is equal to 0. P control refers to a control method for controlling the value of a control target based on a value proportional to the deviation between an instruction value and an estimated value. I control refers to a control method for controlling the value of a control target based on a value proportional to the time integral of the deviation between an instruction value and an estimated value. D control D control refers to a control method for controlling the value of a control target based on a value proportional to the time variation of the deviation between an instruction value and an estimated value. The phase controller 502 according to the present embodiment generates the q-axis current instruction value iq_ref and the d-axis current instruction value id_ref based on PID control. However, the generation method is not limited to this. For example, the phase controller 502 may generate the q-axis current instruction value iq_ref and the d-axis current instruction value id_ref based on PI control. When a permanent magnet is used as the rotor 402, the d-axis current instruction value id_ref affecting the intensity of the magnetic flux penetrating the winding is normally set to 0. However, the control method is not limited to this.

The drive current flowing through the phase A winding of the motor 509 is detected by the current detector 507 and is then converted by an A/D converter 510 from an analog value to a digital value. The drive current flowing through the phase B winding of the motor 509 is detected by the current detector 508 and is then converted by the A/D converter 510 from an analog value to a digital value. A period in which the A/D converter 510 outputs the digital value is, for example, a period (e.g., 25 μs) equal to or less than the period T in which the phase controller 502 acquires the deviation output from the subtracter 101.

The current values of the drive current, which is converted from an analog value to a digital value by the A/D converter 510, are represented as current values iα and iβ in the stationary coordinate system according to formulas (1) and (2), respectively, where θe denotes the phase of the current vector illustrated in FIG. 3. The phase θe of the current vector is defined as the angle formed between the α-axis and the current vector. “I” represents the magnitude of the current vector.

iα=I*cos θe (1)

iβ=I*sin θe (2)

These current values iα and iβ are input to the coordinate converter 511.

The coordinate converter 511 converts the current values iα and iβ in the stationary coordinate system into a current value iq of the q-axis current and a current value id of the d-axis current in the rotating coordinate system by the following formulas (3) and (4).

id=cos θ*iα+sin θ*iβ (3)

iq=−sin θ*iα+cos θ*iβ (4)

The q-axis current instruction value iq_ref output from the phase controller 502 and the current value iq output from the coordinate converter 511 are input to a subtracter 102. The subtracter 102 calculates the deviation between the q-axis current instruction value iq_ref and the current value iq, and outputs the deviation to the current controller 503.

The d-axis current instruction value id_ref output from the phase controller 502 and the current value id output from the coordinate converter 511 are input to a subtracter 103. The subtracter 103 calculates the deviation between the d-axis current instruction value id_ref and the current value id, and outputs the deviation to the current controller 503.

Based on PID control, the current controller 503 generates a drive voltage Vq so as to reduce the deviation output from the subtracter 102. Specifically, the current controller 503 generates the drive voltages Vq so that the deviation output from the subtracter 102 is equal to 0, and outputs the drive voltage Vq to the coordinate inverter 505.

Based on PID control, the current controller 503 generates a drive voltage Vd so as to reduce the deviation output from the subtracter 103. Specifically, the current controller 503 generates the drive voltages Vd so that the deviation output from the subtracter 103 is equal to 0, and outputs the drive voltage Vd to the coordinate inverter 505.

Thus, the current controller 503 functions as a generation unit that generates a drive voltage. The current controller 503 according to the present embodiment generates the drive voltages Vq and Vd based on PID control. However, the generation method is not limited to this. For example, the current controller 503 may generate the drive voltages Vq and Vd based on PI control.

The coordinate inverter 505 reversely converts the drive voltages Vq and Vd in the rotating coordinate system output from the current controller 503 into drive voltages Vα and Vβ, in the stationary coordinate system, by the following formulas (5) and (6).

Vα=cos θ*Vd−sin θ*Vq (5)

Vβ=sin θ*Vd+cos θ*Vq (6)

The coordinate inverter 505 outputs the drive voltages Vα and Vβ, which have been obtained as a result of reverse conversion, to the PWM inverter 506 through a switcher 551. The switcher 551 will be described below.

The PWM inverter 506 includes a full-bridge circuit. The full-bridge circuit is driven by a PWM signal based on the drive voltages Vα and Vβ, output from the coordinate inverter 505. As a result, the PWM inverter 506 generates the drive currents iα and iβ corresponding to the drive voltages Vα and Vβ, respectively, and supplies the drive currents iα and iβ to the windings of the phases of the motor 509 to drive the motor 509. Specifically, the PWM inverter 506 functions as a supply unit that supplies a current to the winding of each phase of the motor 509. Although, in the present embodiment, the PWM inverter includes a full-bridge circuit, the PWM inverter may include a half-bridge circuit.

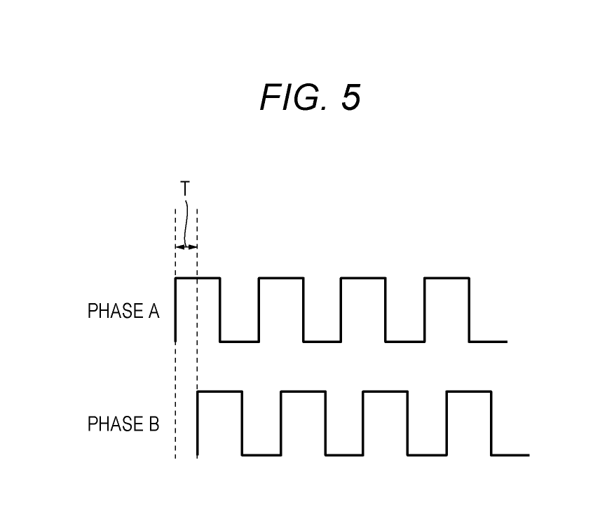

Next, a configuration for determining the rotation phase θ will be described. The rotary shaft of the motor 509 according to the present embodiment is provided with a rotary encoder 512 as a sensor for detecting the rotation phase θ of the rotor. The rotary encoder 512 according to the present embodiment is an increment-type encoder, and outputs a pulse corresponding to the rotation amount and rotation speed of the motor. The present embodiment illustrates an example of a method for determining the rotation phase θ when, as illustrated in FIG. 5, the rotary encoder 512 that outputs a pulse having two phases (phase A and phase B) with a phase difference of 90 degrees is used.

As illustrated in FIG. 4, the pulse output from the rotary encoder 512 is output to a phase determiner 513. The phase determiner 513 detects a rising edge and a falling edge of the phase A and phase B of the pulse output from the rotary encoder 512.

Assuming that the N pulses are output from the rotary encoder 512 during a period in which the rotor of the motor rotates once, the number of riding edges and falling edges of the pulses detected by the phase determiner 513 during the period is represented by 4*N. Accordingly, in a period (represented by T in FIG. 5) from a time when an edge of the phase A is detected to a time when the next edge (i.e., an edge of the phase B) is detected, an amount θm of advancement of the rotation phase of the rotor 402 is represented by the following formula (7).

θm=(P/2)*360/(4*N) (7)

Here, “θm” in Formula (7) represents an electrical angle and 360/(4*N) represents a mechanical angle. A pole number P is a value unique to the motor to be used, and a pulse number N is a value unique to the rotary encoder to be used. In the present embodiment, em is preliminarily stored in the ROM 151b or a memory (not illustrated) provided in the motor control apparatus 157. However, these numbers are not limited to these values. For example, the pole number P and the pulse number N may be set by the operation unit 152 and θm may be determined by the phase determiner 513 based on the set pole number P and pulse number N.

The phase determiner 513 determines the rotation phase θ of the rotor by the following formula (8) based on the number m of detected edges.

θ=θ0+m*θm (8)

Here, “θ0” in Formula (8) represents the rotation phase (initial phase) of the rotor at the time when driving of the motor is started.

In the present embodiment, the phase determiner 513 determines the rotation phase θ by the calculation based on Formula (8). However, the determination method is not limited to this. For example, the phase determiner 513 may determine the rotation phase θ by referring to a table which indicates a relationship between the edge number m and the rotation phase θ corresponding to the edge number m and is stored in the ROM 151b or the like. Further, the phase determiner 513 may be configured to store the rotation phase θ in a memory 513a every time the rotation phase θ is output, and to output the rotation phase obtained by adding θm to the rotation phase θ stored in the memory 513a every time an edge of the pulse output from the rotary encoder 512 is detected. Specifically, the phase determiner 513 determines the rotation phase θ by the following formula (9) and outputs the determined rotation phase θ.

θ=θ+θm (9)

The rotation phase θ of the rotor 402 obtained as described above is input to each of the subtracter 101, the coordinate inverter 505, and the coordinate converter 511.

The motor control apparatus 157 repeatedly performs the above-described control processing.

As described above, the motor control apparatus 157 according to the present embodiment performs vector control using phase feedback control for controlling the current value in the rotating coordinate system so as to reduce the deviation between the instruction phase θ_ref and the rotation phase θ. The execution of vector control prevents the motor from entering a step-out state, and also prevents an increase in motor sound and an increase in power consumption due to excessive torque. Further, in the phase feedback control, the rotation phase of the rotor is controlled so that the rotation phase of the rotor becomes a desired/predetermined phase. Accordingly, in the image forming apparatus 100, vector control using phase feedback control is applied to the motor which drives loads (e.g., registration rollers and the like) that are required to accurately control the rotation phase of the rotor, thereby appropriately forming an image of the recording medium.

<Initial Phase θ0>

Next, a method for determining the initial phase GO represented by Formula (8) will be described in comparison with a related art method.

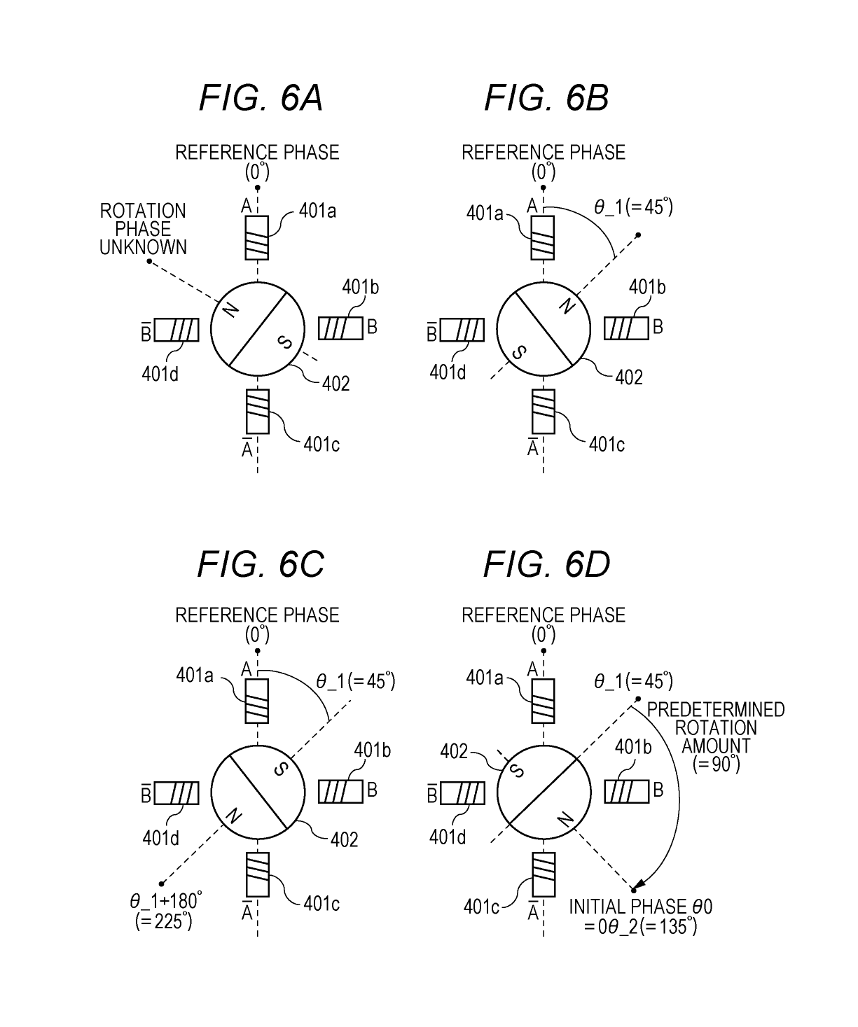

FIGS. 6A to 6D are diagrams each illustrating a method for determining an initial phase θ0. First, the method for determining the initial phase θ0 of the related art will be described with reference to FIGS. 6A to 6D.

FIG. 6A is a diagram illustrating a state where the rotation phase of the rotor is unknown (the initial phase θ0 is not determined).

In the state illustrated in FIG. 6A, for example, when the instruction phase θ_ref is output so that the rotation phase of the rotor becomes a phase θ_1 (e.g., 45°), the rotor is attracted to the magnetic flux due to the current supplied to the winding according to the instruction phase θ_ref. In consequence, as illustrated in FIG. 6B, the rotation phase θ of the rotor becomes the phase θ_1. As a result, the phase θ_1 is determined to be the initial phase θ0.

However, even when the instruction phase θ_ref is output so that the rotation phase of the rotor becomes the phase θ_1 (e.g., 45°), the rotor may not be attracted to the magnetic flux due to the current supplied to the winding according to the instruction phase θ_ref depending on the rotation phase of the rotor before the winding is excited. Specifically, when the rotor before the winding is excited is in the state illustrated in FIG. 6C, i.e., when the rotation phase θ of the rotor before the winding is excited is represented by (θ_1+180°), the rotor is not rotated even when the phase θ_1 is output as the instruction phase θ_ref. In this case, when the phase θ_1 is determined to be the initial phase θ0, the phase difference between the determined initial phase θ0 (=θ_1) and the actual rotation phase θ (=θ_1+180°) of the rotor is 180°. If the motor control based on the initial phase GO is started in a state where the phase difference between the initial phase θ0 (=θ_1) and the actual rotation phase θ (=θ_1+180°) of the rotor is 180°, the motor control may become unstable.

Accordingly, in the present embodiment, the following configuration is applied to the motor control apparatus 157, thereby preventing the motor control from being unstable.

As illustrated in FIG. 4, the motor control apparatus 157 according to the present embodiment includes a voltage generator 550 and the switcher 551 as a configuration for performing a mode (second control mode) for determining the initial phase θ0.

The CPU 151a outputs the instruction phase θ_ref to the voltage generator 550. The voltage generator 550 generates and outputs the drive voltages Vα and Vβ, based on the instruction phase θ_ref output from the CPU 151a.

Further, the CPU 151a outputs, to the switcher 551, a switching signal for switching the state of the switcher 551. For example, when the CPU 151a controls the switcher 551 so that the drive voltages Vα and Vβ, output from the voltage generator 550 are output to the PWM inverter 506, the CPU 151a sets the switching signal to ‘H’. Further, when the CPU 151a controls the switcher 551 so that the drive voltages Vα and Vβ, output from the coordinate inverter 505 are output to the PWM inverter 506, the CPU 151a sets the switching signal to ‘L’. The switching signal is output, for example, during the same period as the period in which the CPU 151a outputs the instruction phase θ_ref.

The PWM inverter 506 supplies the drive currents corresponding to the input drive voltages Vα and Vβ, to the windings of the motor by the above-described method.

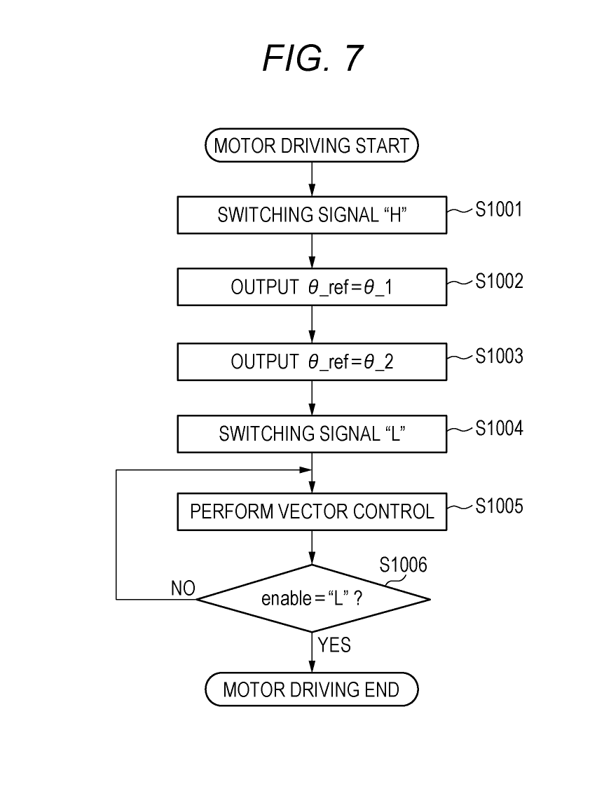

FIG. 7 is a flowchart illustrating a method for controlling the motor by the motor control apparatus 157. The control for the motor 509 according to the present embodiment will be described below with reference to FIG. 7. The processing in this flowchart is executed by the CPU 151a.

First, when an enable signal ‘H’ is output from the CPU 151a to the motor control apparatus 157, the motor control apparatus 157 starts driving of the motor 509 based on an instruction output from the CPU 151a. The enable signal refers to a signal for permitting or prohibiting the operation of the motor control apparatus 157. When the enable signal at ‘L (low level)’, the CPU 151a prohibits the operation of the motor control apparatus 157. In other words, the processing for controlling the motor 509 by the motor control apparatus 157 is terminated. When the enable signal is at ‘H (high level)’, the CPU 151a permits the operation of the motor control apparatus 157 and the motor control apparatus 157 controls the motor 509 based on the instruction output from the CPU 151a.

Next, in step S1001, the CPU 151a sets the switching signal to “H” and outputs the switching signal so that the drive voltages Vα and Vβ, output from the voltage generator 550 are output to the PWM inverter 506.

In step S1002, the CPU 151a outputs the phase θ_1 (e.g., 45°) as the instruction phase θ_ref. As a result, a current is supplied to the windings so that the rotation phase θ of the rotor becomes the phase θ_1, and a magnetic flux is generated due to the supplied current. The phase θ_1 is a predetermined phase and is stored in, for example, the ROM 151b.

After that, in step S1003, the CPU 151a outputs, as the instruction phase θ_ref, a phase θ_2 (e.g., 135°) having a phase difference other than 0° and 180° between the phase θ_1 and the phase θ_2. As a result, a current is supplied to the windings so that the rotation phase θ of the rotor becomes the phase θ_2, and a magnetic flux is generated due to the supplied current. As a result, the rotor is rotated by the magnetic flux due to the current supplied in step S1003, without rotating the rotor in step S1002, so that the rotation phase θ of the rotor becomes the phase θ_2 as illustrated in FIG. 6D. The phase θ_2 is a predetermined phase and is stored in, for example, the ROM 151b.

In step S1004, the CPU 151a sets the switching signal to ‘L’ and outputs the switching signal so that the drive voltages Vα and Vβ, output from the coordinate inverter 505 are output to the PWM inverter 506.

In step S1005, the motor control apparatus 157 performs vector control phased on the initial phase θ0 (=θ_2). In the present embodiment, θ_2 is preliminarily stored as the initial phase θ0 in the memory (not illustrated) that is provided in the phase determiner 513. However, the method for obtaining the initial phase θ0 is not limited to this. For example, θ_2 may be input from the CPU 151a to the phase determiner 513 as the initial phase θ0.

After that, the motor control apparatus 157 repeatedly performs the above-described control processing until the CPU 151a outputs the enable signal ‘L’ to the motor control apparatus 157. The magnitude of the current supplied to the windings in the mode (second control mode) for determining the initial phase θ0 is preliminarily set.

As described above, in the present embodiment, the phase θ_1 is first output as the instruction phase θ_ref. As a result, a current is supplied to the windings so that the rotation phase θ of the rotor becomes the phase θ_1, and a magnetic flux is generated due to the supplied current. After that, the phase θ_2 is output as the instruction phase θ_ref. As a result, a current is supplied to the windings so that the rotation phase θ of the rotor becomes the phase θ_2, and a magnetic flux is generated due to the supplied current. As a result, the rotor is rotated by the magnetic flux due to the current corresponding to the phase θ_2, without rotating the rotor when the phase θ_1 is output as the instruction phase θ_ref, so that the rotation phase θ of the rotor becomes the phase θ_2 as illustrated in FIG. 6D. In other words, a desired phase θ_2 can be determined as the initial phase θ0 in the motor control.

With this configuration, it is possible to prevent the motor control from being started based on an initial phase different from the actual rotation phase of the rotor. As a result, it is possible to prevent the motor control from being unstable.

In the present embodiment, the vector control is performed based on the initial phase θ0 and the signal output from the rotary encoder. However, the vector control is not limited to this. For example, even when the vector control is performed based on the initial phase θ0 and the rotation phase of the rotor determined based on an inductance of each winding, the present embodiment can be applied.

Further, in the present embodiment, after the phase θ_1 is output as the instruction phase θ_ref, the phase θ_2 is output as the instruction phase θ_ref and the phase θ_2 is determined as the initial phase θ0 in the motor control. However, the present disclosure is not limited to this method. For example, after the phase θ_1 is output as the instruction phase θ_ref, the phase θ_2 may be output as the instruction phase θ_ref and, in addition, a phase θ_3 may be output as the instruction phase θ_ref and the phase θ_3 may be determined as the initial phase θ0 in the motor control. Specifically, the instruction phase θ_ref may be output a plurality of times (twice or more), and the phase indicated by the instruction phase θ_ref that is the last one of the plurality of output instruction phases θ_ref may be determined as the initial phase θ0 in the motor control. In this case, however, the smaller the number of output instruction phases θ_ref before the initial phase θ0 is determined, the sooner the motor control is started.

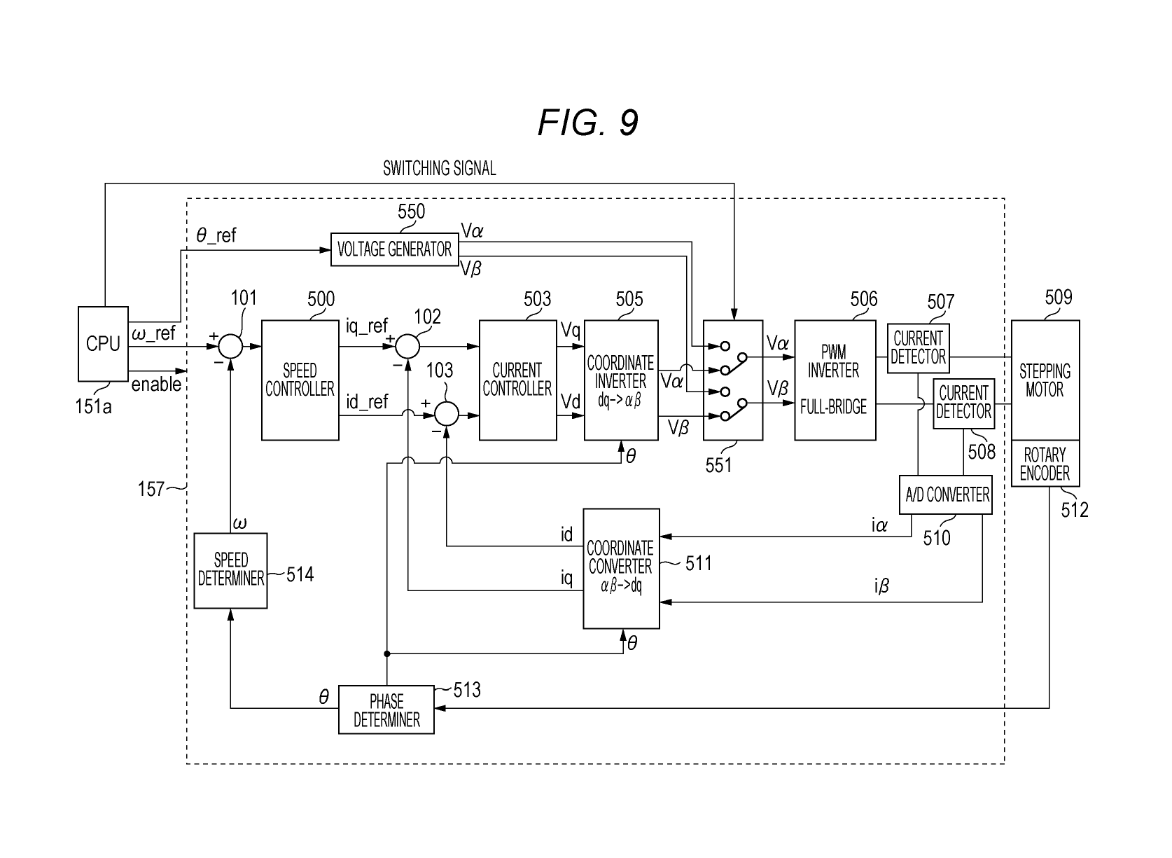

In the vector control according to the present embodiment, the motor 509 is controlled by phase feedback control. However, the vector control is not limited to this. For example, the motor 509 may be controlled by feeding back a rotation speed ω of the rotor 402. Specifically, as illustrated in FIG. 9, a speed determiner 514 is provided in the motor control apparatus, the speed determiner 514 determines the rotation speed ω by the following formula (10) based on the rotation phase θ output from the phase determiner 513.

ω=dθ/dt (10)

Further, the CPU 151a outputs an instruction speed ω_ref representing a target speed of the rotor. Further, a speed controller 500 is provided in the motor control apparatus, and the speed controller 500 is configured to generate and output a q-axis current instruction value iq_ref so as to reduce the deviation between the rotation speed ω and the instruction speed ω_ref. The motor 509 may be controlled by performing such a speed feedback control. In this configuration, the rotation speed is fed back, thereby allowing control of the rotation speed of the rotor so as to attain a predetermined speed. Accordingly, in the image forming apparatus 100, vector control using speed feedback control is applied to the motor that drives loads (e.g., the photosensitive drum, the conveyance belt, and the like) that are required to be controlled to maintain a constant rotation speed so that image formation on a recording medium can be appropriately performed. As a result, image formation on a recording medium can be appropriately performed.

In the first and second embodiments, the stepping motor is used as the motor for driving loads, and instead other motors such as a direct current (DC) motor may be used. The motor is not limited to a 2-phase motor, and instead the present embodiment may be applied to other motors such as a 3-phase motor.

In the first and second embodiments, the permanent magnet is used as the rotor, but the rotor is not limited to this.

A circuit used when vector control (first control mode) according to the present embodiment is performed corresponds to a first control circuit according to the present disclosure. Further, a circuit used in the second control mode according to the present embodiment is performed corresponds to a second control circuit according to the present disclosure.

According to the present disclosure, it is possible to prevent motor control from being unstable.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2017-113619, filed Jun. 8, 2017, which is hereby incorporated by reference herein in its entirety.

What is claimed is:

1. A motor control apparatus to control a motor based on an instruction phase representing a target phase of a rotor of the motor, the motor control apparatus comprising:
a phase determiner configured to determine a rotation phase of the rotor of the motor; and
a controller having a first control mode for controlling a drive current flowing through a winding of the motor, based on a torque current component generating a torque in the rotor, so as to reduce a deviation between the instruction phase and the rotation phase determined by the phase determiner, and a second control mode for controlling a current corresponding to the instruction phase to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

2. The motor control apparatus according to claim 1,
wherein the phase determiner includes a rotary encoder configured to detect a rotation amount of the rotor, and
wherein the phase determiner determines the rotation phase of the rotor based on the rotation amount detected by the rotary encoder.

3. The motor control apparatus according to claim 1, further comprising:
a first control circuit configured to supply a drive current to each of a winding of a first phase of the motor and a winding of a second phase of the motor in a case where the first control mode is executed;
a second control circuit configured to supply the drive current to each of the winding of the first phase of the motor and the winding of the second phase of the motor in a case where the second control mode is executed; and
a switcher configured to switch between control of the motor using the first control circuit and control of the motor using the second control circuit.

4. The motor control apparatus according to claim 1,
wherein the controller includes a detector configured to detect the drive current flowing through the winding,
wherein the first control mode is a control mode to control the motor by controlling a value of an exciting current component of the drive current detected by the detector to be set to 0 and controlling a value of the torque current component of the drive current detected by the detector, and
wherein the exciting current component is a current component represented in the rotating coordinate system and affecting an intensity of a magnetic flux penetrating the winding.

5. The motor control apparatus according to claim 1, wherein the current supplied to the winding in the second control mode is a predetermined current.

6. A motor control apparatus to control a motor based on an instruction speed representing a target speed of a rotor of the motor, the motor control apparatus comprising:
a phase determiner configured to determine a rotation phase of the rotor of the motor; and
a speed determiner configured to determine a rotation speed of the rotor; and
a controller having a first control mode for controlling a drive current flowing through a winding of the motor, based on a torque current component generating a torque in the rotor, so as to reduce a deviation between the instruction speed and the rotation speed determined by the speed determiner, and a second control mode for controlling a current corresponding to the instruction phase representing a target phase of the rotor to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

7. The motor control apparatus according to claim 6,
wherein the phase determiner includes a rotary encoder configured to detect a rotation amount of the rotor, and
wherein the phase determiner determines the rotation phase of the rotor based on the rotation amount detected by the rotary encoder.

8. The motor control apparatus according to claim 6, further comprising:
a first control circuit configured to supply a drive current to each of a winding of a first phase of the motor and a winding of a second phase of the motor in a case where the first control mode is executed;
a second control circuit configured to supply the drive current to each of the winding of the first phase of the motor and the winding of the second phase of the motor in a case where the second control mode is executed; and
a switcher configured to switch between control of the motor using the first control circuit and control of the motor using the second control circuit.

9. The motor control apparatus according to claim 6, wherein
wherein the controller includes a detector configured to detect the drive current flowing through the motor winding,
wherein the first control mode is a control mode to control the motor by controlling a value of an exciting current component of the drive current detected by the detector to be set to 0 and controlling a value of the torque current component of the drive current detected by the detector, and
wherein the exciting current component is a current component represented in the rotating coordinate system and affecting an intensity of a magnetic flux penetrating the winding.

10. The motor control apparatus according to claim 6, wherein the current supplied to the winding in the second control mode is a predetermined current.

11. A sheet conveyance apparatus to convey a sheet, the sheet conveyance apparatus comprising:
a conveyance roller configured to convey a sheet;
a motor configured to drive the conveyance roller;
a phase determiner configured to determine a rotation phase of a rotor of the motor; and
a controller having a first control mode and, to supply a current through a winding of the motor, based on a torque current component generating a torque in the rotor, so as to reduce a deviation between the instruction phase representing a target phase of the rotor and the rotation phase determined by the phase determiner, and a second control mode for controlling a current corresponding to the instruction phase to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

12. A document feeding apparatus to feed a document, the document feeding apparatus comprising:
a document tray on which a document is to be stacked;
a conveyance roller configured to convey the document stacked on the document tray;
a motor configured to drive the conveyance roller;
a phase determiner configured to determine a rotation phase of a rotor of the motor; and
a controller having a first control mode for controlling a drive current flowing through a winding of the motor, based on a torque current component generating a torque in the rotor, so as to reduce a deviation between the instruction phase representing a target phase of the rotor and the rotation phase determined by the phase determiner, and a second control mode for controlling a current corresponding to the instruction phase to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

13. A document reading apparatus to read an image of a document, the document reading apparatus comprising:
a document tray on which a document is to be stacked;
a conveyance roller configured to convey the document stacked on the document tray;
a reading unit configured to read the document conveyed by the conveyance roller;
a motor configured to drive the conveyance roller;
a phase determiner configured to determine a rotation phase of a rotor of the motor; and
a controller having a first control mode for controlling a drive current flowing through a winding of the motor, based on a torque current component generating a torque in the rotor, so as to reduce a deviation between the instruction phase representing a target phase of the rotor and the rotation phase determined by the phase determiner, and a second control mode for controlling a current corresponding to the instruction phase to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

14. An image forming apparatus to form an image on a recording medium, the image forming apparatus comprising:
an image forming unit configured to form an image on the recording medium;
a motor configured to drive a load;
a phase determiner configured to determine a rotation phase of a rotor of the motor; and
a controller having a first control mode for controlling a drive current flowing through a winding of the motor, based on a torque current component generating a torque in the rotor, so as to reduce a deviation between the instruction phase representing a target phase of the rotor and the rotation phase determined by the phase determiner, and a second control mode for controlling a current corresponding to the instruction phase to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

15. The image forming apparatus according to claim 14, wherein the load is a conveyance roller configured to convey the recording medium.

16. An image forming apparatus to form an image on a recording medium, the image forming apparatus comprising:
an image forming unit configured to form an image on the recording medium;
a motor configured to drive a load;
a phase determiner configured to determine a rotation phase of a rotor of the motor;
a speed determiner configured to determine a rotation speed of the rotor; and
a controller having a first control mode for controlling a drive current flowing through a winding of the motor, based on a torque current component generating a torque in the rotor, so as to reduce a deviation between the instruction speed representing a target speed of the rotor and the rotation speed determined by the speed determiner, and a second control mode for controlling a current corresponding to the instruction phase to the winding,
wherein the torque current component is represented in a rotating coordinate system based on the rotation phase determined by the phase determiner,
wherein, in the second control mode, the controller controls the drive current in such a manner that a current corresponding to a first instruction phase as the instruction phase flows through the winding and then controls the drive current in such a manner that a current corresponding to a second instruction phase flows through the winding,
wherein the second instruction phase has a phase difference other than 0° and 180° between the first instruction phase and the second instruction phase,
wherein the phase determiner determines the rotation phase of the rotor based on the second instruction phase, and
wherein the controller starts the first control mode based on the rotation phase of the rotor determined by the phase determiner based on the second instruction phase in the second control mode.

17. The image forming apparatus according to claim 16, wherein the image forming unit includes:
a photosensitive drum;
a developing unit configured to develop a latent image formed on the photosensitive drum; and
a transfer unit configured to transfer a toner image developed by the developing unit onto the recording medium,
wherein the motor drives the photosensitive drum as the load.
